(19) United States
(12) Patent Application Publication
(10) Pub. No.: US 2008/0170699 A1
(43) Pub. Date: Jul. 17, 2008

(54) METHOD AND DEVICE FOR MANAGING A WIRELESS RESOURCE

(75) Inventors: Marco Fratti, St. Germain en Laye (FR); Jean-Noel Patillon, Paris (FR)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/622,797

(22) Filed: Jan. 12, 2007

(51) Int. Cl. H04L 9/08

(52) U.S. Cl. 380/278

(57) ABSTRACT

A method and device for managing a wireless resource are useful for securely transmitting data in a wireless communication network. The method includes receiving at a target wireless communication device an encrypted identification of a relaying wireless communication device, an encrypted payload decryption key, and an encrypted payload. The encrypted identification is then decrypted using an identification decryption key stored in a memory of the target wireless communication device, and the decrypted identification is used to authenticate the relaying wireless communication device. The encrypted payload decryption key is decrypted using a key decryption key stored in a memory of the target wireless communication device and a decryption algorithm stored in a memory of the target wireless communication device, which provides a decrypted payload decryption key. The encrypted payload is then decrypted using the decrypted payload decryption key.

### FIELD OF THE INVENTION

The present invention relates generally to communicating data through wireless communication networks, and in particular to managing radio resources using virtual network cells to relay data.

### BACKGROUND

Relay-based wireless communication networks, such as ad hoc or mesh wireless communication networks, can improve quality of service (QoS) network performance by increasing network coverage areas. In relay-based networks, network elements such as repeaters and individual mobile stations function as relays, thereby forming virtual network cells. A centroid of a virtual network cell is a location of a network element functioning as a relay. Other network elements therefore may be able to communicate directly with a virtual network cell, even if the other network elements are unable to communicate directly with a primary network cell such as a radio access network (RAN).

Maintaining security of data that are relayed through virtual network cells represents a significant challenge to the wireless communication industry. In classical RAN-based systems, malicious “pirate base stations” can be deployed that seek to emulate network elements with which legitimate network subscribers communicate. The legitimate network subscribers then risk providing sensitive information to the pirate base stations. Similar problems can arise in relay-based wireless communication networks, where malicious “pirate relays” can be deployed. Such pirate relays then can obtain sensitive information from legitimate subscriber elements such as mobile stations. Pirate relays thus can present significant network security risks, particularly in ad-hoc and mesh wireless communication networks that use intelligent algorithms to determine how data are routed through a network.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a diagram illustrating elements of a wireless communication network that perform radio resource management functions, including reception and decryption of messages, according to some embodiments of the present invention.

FIG. 2 is a diagram illustrating a method for managing a wireless resource, including decrypting a first encrypted message at a target mobile station in a wireless communication network, according to some embodiments of the present invention.

FIG. 3 is a general flow diagram illustrating a method for managing a wireless resource, according to some embodiments of the present invention.

FIG. 4 is a block diagram illustrating components of a target mobile station that can function as a target wireless communication device, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to managing a wireless resource in a wireless communication network. Accordingly, the apparatus components and method steps have been represented where appropriate by conventional symbols in the drawings, showing only those specific details that are pertinent to understanding the embodiments of the present invention, so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of managing a wireless resource in a wireless communication network as described herein. The non-processor circuits may include, but are not limited to, a radio receiver, a radio transmitter, signal drivers, clock circuits, power source circuits, and user input devices. As such, these functions may be interpreted as steps of a method for managing a wireless resource. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

According to one aspect, some embodiments of the present invention define a method for managing a wireless resource. The method includes receiving at a target wireless communication device an encrypted identification of a relaying wireless communication device, an encrypted payload decryption key, and an encrypted payload. The encrypted identification is then decrypted using an identification decryption key stored in a memory of the target wireless communication device, and the decrypted identification is used to authenticate the relaying wireless communication device. The encrypted payload decryption key is decrypted using a key decryption key stored in a memory of the target wireless communication device and a decryption algorithm stored in a memory of the target wireless communication device, which provides a decrypted payload decryption key. The encrypted payload is then decrypted using the decrypted payload decryption key. Some embodiments of the present invention therefore enable a plurality of decryption keys and decryption algorithms to be used to securely relay in a wireless communication network data concerning various radio resource management (RRM) functions. For example, such RRM functions can include paging, node attachments, radio connection admission control (CAC), and handover handshakes in ad hoc and mesh wireless communication networks.

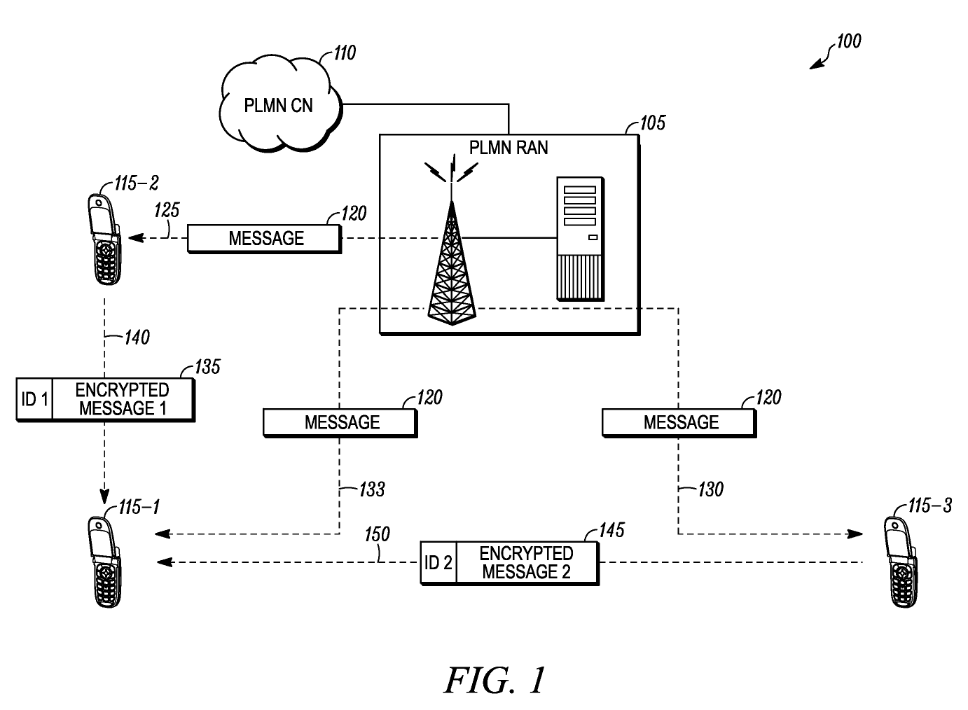

Referring to FIG. 1, a diagram illustrates elements of a wireless communication network 100 that perform radio resource management functions, including reception and decryption of messages, according to some embodiments of the present invention. The wireless communication network 100 includes a public land mobile network (PLMN) radio access network (RAN) 105 that is operatively connected to a PLMN core network (CN) 110. The wireless communication network 100 further includes a plurality of mobile stations (MSs) 115-n, including a target MS 115-1, a first relaying MS 115-2 and a second relaying MS 115-3.

Consider that the PLMN RAN 105 broadcasts a message 120, such as a phone call alert paging message for the target MS 115-1, to the plurality of MSs 115-n in the wireless communication network 100. Line 125 represents that the message 120 is transmitted from the PLMN RAN 105 to the first relaying MS 115-2 using a PLMN common channel on a carrier frequency that has good reception at the first relaying MS 115-2. Similarly, line 130 represents that the message 120 is transmitted from the PLMN RAN 105 to the second relaying MS 115-3 using the PLMN common channel on a carrier frequency that also has good reception at the second relaying MS 115-3. Thus the message 120 is successfully received at both the first relaying MS 115-2 and at the second relaying MS 115-3. However, consider that line 133 represents that the message 120 is transmitted from the PLMN RAN 105 to the target MS 115-1, but the PLMN common channel carrier frequency has bad reception at the target MS 115-1. Thus the message 120 is not successfully received at the target MS 115-1. Those skilled in the art will appreciate that such bad reception of the PLMN common channel carrier frequency at the target MS 115-1 can occur for various reasons including, for example, the target MS 115-1 being out of range of the PLMN RAN 105, or radio frequency (RF) interference caused by sources of RF noise or by obstructions such as buildings.

According to some embodiments of the present invention, the target MS 115-1 is able to successfully receive the message 120 in an encapsulated form of a first encrypted message 135 that is received from the first relaying MS 115-2, as represented by line 140, over a common channel low bit-rate frequency. The target MS 115-1 is also able to successfully receive the message 120 in an encapsulated form of a second encrypted message 145 that is received from the second relaying MS 115-3, as represented by line 150, over the common channel low bit-rate frequency. As described in detail below, the first encrypted message 135 or the second encrypted message 145 then can be decrypted at the target MS 115-1 to obtain the message 120. According to some embodiments of the present invention, the low bit-rate frequency of the common channel can be the same for the transmissions from both the first relaying MS 115-2 (represented by line 140) and the second relaying MS 115-3 (represented by line 150). Separation of such transmissions then can be obtained using appropriate time/phase shift procedures, which procedures are well known by those having ordinary skill in the art.

Phone call alert paging messages are just one example of an encrypted payload application that can be managed according to the present invention. Those skilled in the art will appreciate that other embodiments of the present invention can include various other types of encrypted payloads. For example, concerning downlink applications (i.e., from a network to a mobile station) encrypted payloads can include broadcast control channel (BCCH) data, paging control channel (PCCH) data, fast associated control channel (FACCH) data, and access grant channel (AGCH) data. Concerning uplink applications (i.e., from a mobile station to a network), encrypted payloads can include random access channel (RACH) data. Further, concerning both downlink and uplink applications, encrypted payloads can include slow associated control channel (SACCH) data and fast associated control channel (FACCH) data. Encrypted payloads therefore can include various radio resource control messages. Such messages can be received using a physical channel identifier that is known by all receivers operating in a wireless communication network.

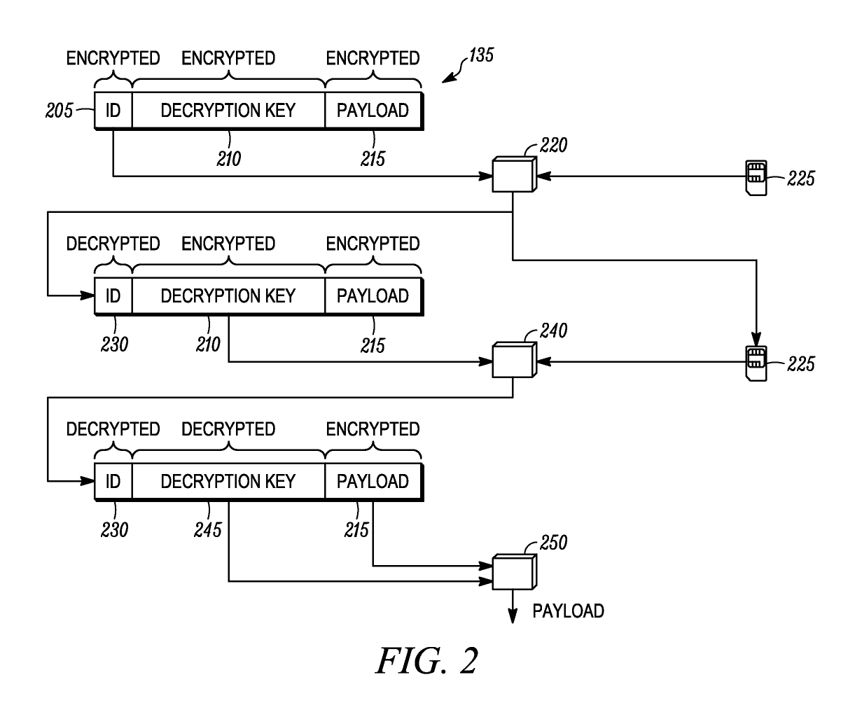

Referring to FIG. 2, a diagram illustrates a method for managing a wireless resource, including decrypting the first encrypted message 135 at the target MS 115-1 in the wireless communication network 100, according to some embodiments of the present invention. The first encrypted message 135 comprises an encrypted identification 205 of the first relaying MS 115-2, an encrypted payload decryption key 210, and an encrypted payload 215. For example, the encrypted payload 215 may comprise paging control channel (PCCH) data including the message 120. At block 220, the target MS 115-1 bootstraps an identification decryption key from a first memory of the target MS 115-1, such as a subscriber identify module (SIM) card 225. Such an identification decryption key is a root key that can be programmed into the first memory by a network operator of the wireless communication network 100. For example, the identification decryption key can be unique for an operator SIM card fleet for the wireless communication network 100. A computational unit of the target MS 115-1 then decrypts the encrypted identification 205 using the identification decryption key and authenticates the first relaying MS 115-2.

Authentication of the first relaying MS 115-2 can occur in various ways. For example, the encrypted identification 205 can comprise a scrambled concatenation of a device identifier, such as an international mobile equipment identity (IMEI), and a subscriber identifier, such as an international mobile subscriber identity (IMSI). After the encrypted identification 205 is descrambled into a decrypted identification 230, the target MS 115-1 can transmit the IMEI and IMSI of the first relaying MS 115-2 to the PLMN RAN 105. A server then completes authentication of the IMEI and IMSI. If the authentication is successful, the PLMN RAN 105 transmits a message back to the target MS 115-1 confirming the authentication. The target MS 115-1 then can continue the process of decrypting the first encrypted message 135.

At block 240, the encrypted payload decryption key 210 is decrypted. For example, the encrypted payload decryption key 210 can comprise an electronic certificate signed by a certification authority, where the electronic certificate includes information for decrypting the encrypted payload decryption key 210. Such certificates are well known in the art concerning public key infrastructure (PKI) arrangements. The target MS 115-1 bootstraps a PKI public key from a second memory of the target MS 115-1. The second memory can be, for example, a tamper-resistant, built-in memory of the target MS 115-1. Thus the public key can be a hardware-based key that is under the control of a manufacturer of the target MS 115-1, and therefore provides an additional level of security concerning the first encrypted message 135.

A decryption algorithm stored in the first memory, such as the SIM card 225, enables decrypting and verifying the electronic certificate of the encrypted payload decryption key 210. After the electronic certificate is verified, additional information, such as a hash signature, can be obtained from the electronic certificate. A composite key, comprising for example the public key and the hash signature, then can be derived in order to decrypt the encrypted payload decryption key 210 to form a decrypted payload decryption key 245. For security, the public key and the hash signature derived from the encrypted payload decryption key 210 then can be erased from the first memory by the target MS 115-1.

At block 250, the encrypted payload 215 is decrypted using the decrypted payload decryption key 245 to recover the message 120. Using the identification of the first relaying MS 115-2, the target MS 115-1 then can respond to the message 120 by relaying a response message back to the PLMN RAN 105 through the first relaying MS 115-2.

It is apparent that the target MS 115-1 receives two messages: the first encrypted message 135 from the first relaying MS 115-2, and the second encrypted message 145 from the second relaying MS 115-3. As known by those having ordinary skill in the art, various options are available for processing such redundant information. For example, selections can be made based on a cyclic redundancy check (CRC) of the payload in the first encrypted message 135 and the payload in the second encrypted message 145. Alternatively, the redundant information can be combined using maximum likelihood estimation (MLE) techniques.

Some embodiments of the present invention therefore enable effective operation of virtual network cells in a wireless communication network. For example, the first relaying MS 115-2 and the second relaying MS 115-3 each can act as a virtual network cell in the wireless communication network 100. Concurrent common channel decoding in such virtual network cells can improve decoding efficiency and thus improve overall network operating efficiency and quality of service (QoS). Further, network QoS can be improved by reducing decoding delays and reducing call setup failures. Also, significant battery power savings can be achieved at the target MS 115-1, because less transmission power is required to transmit data to the virtual network cells, such as the first relaying MS 115-2, than to transmit data directly from the target MS 115-1 to the PLMN RAN 105. Further, some embodiments of the present invention enable the wireless communication network 100 to be intrinsically resilient, as a fine grid of virtual cells can increase mean time between failure (MTBF) network statistics.

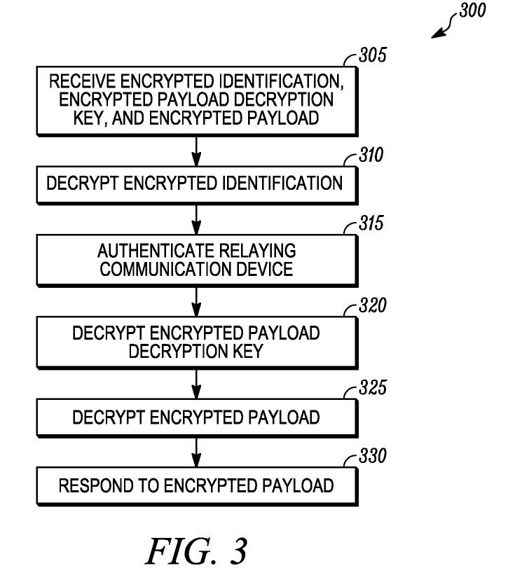

Referring to FIG. 3, a general flow diagram illustrates a method 300 for managing a wireless resource, according to some embodiments of the present invention. At step 305, an encrypted identification of a relaying wireless communication device, an encrypted payload decryption key, and an encrypted payload are received at a target wireless communication device. For example, in the wireless communication network 100, the encrypted identification 205 of the first relaying MS 115-2, the encrypted payload decryption key 210, and the encrypted payload 215 of the first encrypted message 135 are received at the target MS 115-1.

At step 310, the encrypted identification is decrypted using an identification decryption key stored in a memory of the target wireless communication device to obtain a decrypted identification. For example, the target MS 115-1 decrypts the encrypted identification 205 using a root key programmed into the SIM card 225.

At step 315, the relaying wireless communication device is authenticated using the decrypted identification. For example, the encrypted identification 205 is descrambled into a decrypted identification 230, and the target MS 115-1 transmits the IMEI and IMSI of the first relaying MS 115-2 to the PLMN RAN 105 for authentication. Alternatively, the IMEI and IMSI of the first relaying MS 115-2 can be verified using a dedicated authentication server.

At step 320, the encrypted payload decryption key is decrypted using a key decryption key stored in a memory of the target wireless communication device, and a decryption algorithm stored in a memory of the target wireless communication device, to obtain a decrypted payload decryption key. For example, the encrypted payload decryption key 210 is decrypted by the target MS 115-1 bootstrapping a PKI public key from a second memory of the target MS 115-1, and a decryption algorithm stored in the SIM card 225 enables decrypting and verifying the electronic certificate of the encrypted payload decryption key 210.

At step 325, the encrypted payload is decrypted using the decrypted payload decryption key. For example, the encrypted payload 215 is decrypted using the decrypted payload decryption key 245 to recover the message 120. Finally, at step 330, the target wireless communication device responds to the encrypted payload using the identification of the relaying wireless communication device. For example, using the identification of the first relaying MS 115-2, the target MS 115-1 responds to the message 120 by relaying a response message back to the PLMN RAN 105 through the first relaying MS 115-2.

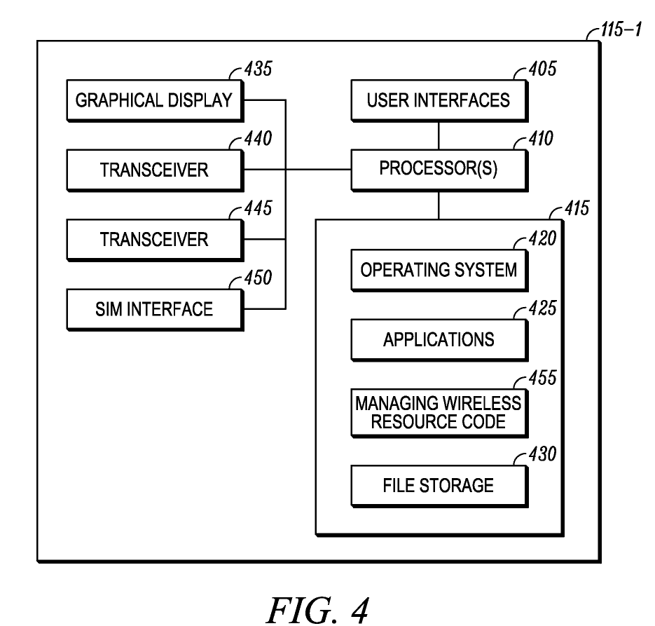

Referring to FIG. 4, a block diagram illustrates components of the target MS 115-1 that can function as a target wireless communication device, according to some embodiments of the present invention. The target MS 115-1 can be, for example, a two-way radio, a mobile telephone, a notebook computer, or another type of device operating as a network node in a relay-based network such as a Worldwide Interoperability for Microwave Access (WiMAX) network. The target MS 115-1 comprises user interfaces 405 operatively coupled to at least one processor 410. A first memory 415 is also operatively coupled to the processor 410. The first memory 415 has storage sufficient for an operating system 420, applications 425 and general file storage 430. The general file storage 430 can function, for example, as a tamper-resistant, in-built memory for storing a PKI public key used to decrypt the encrypted payload decryption key 210. The user interfaces 405 can be a combination of user interfaces including, for example, but not limited to a keypad, a touch screen, a microphone and a communications speaker. A graphical display 435, which can also have a dedicated processor and/or memory, drivers, etc., is operatively coupled to the processor 410. A number of transceivers, such as a first transceiver 440 and a second transceiver 445, are also operatively coupled to the processor 410. The first transceiver 440 and the second transceiver 445 communicate with various wireless communications networks, such as the wireless communication network 100, using various standards such as, but not limited to, Evolved Universal Mobile Telecommunications Service Terrestrial Radio Access (E-UTRA), Universal Mobile Telecommunications System (UMTS), Enhanced UMTS (E-UMTS), Enhanced High Rate Packet Data (E-HRPD), Code Division Multiple Access 2000 (CDMA2000), Institute of Electrical and Electronics Engineers (IEEE) 802.11, IEEE 802.16, and other standards. A subscriber identity module (SIM) interface 450 can be operatively coupled to a SIM card, such as the SIM card 225.

It is to be understood that FIG. 4 is for illustrative purposes only and includes only some components of the target MS 115-1, in accordance with some embodiments of the present invention, and is not intended to be a complete schematic diagram of the various components and connections between components required for all devices that may implement various embodiments of the present invention.

The first memory 415 comprises a computer readable medium that records the operating system 420, the applications 425, and the general file storage 430. The computer readable medium also comprises computer readable program code components 455 concerning managing a wireless resource in a wireless communication network. When the computer readable program code components 455 are processed by the processor 410, they are configured to cause execution of the method 300 for managing a wireless resource, as described above, according to some embodiments of the present invention.

Advantages of some embodiments of the present invention thus include enabling a plurality of decryption keys and decryption algorithms to be used to securely relay wireless communication network data concerning various radio resource management (RRM) functions; enabling effective operation of virtual network cells; enabling concurrent common channel decoding in virtual network cells to improve decoding efficiency and improve overall network operating efficiency; enabling improved QoS by reducing decoding delays and reducing call setup failures; enabling mobile station battery power savings by reducing transmission power levels required to transmit data to virtual wireless network cells; and enabling a fine grid of virtual wireless network cells to increase overall mean time between failure (MTBF) network statistics.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage, or solution to occur or become more pronounced are not to be construed as critical, required, or essential features or elements of any or all the claims. The invention is defined solely by the appended claims including any amendments made during the pendency of this application and all equivalents of those claims as issued.

We claim:

1. A method for managing a wireless resource, the method comprising:
receiving at a target wireless communication device an encrypted identification of a relaying wireless communication device, an encrypted payload decryption key, and an encrypted payload;
decrypting the encrypted identification using an identification decryption key stored in a memory of the target wireless communication device to obtain a decrypted identification;
authenticating the relaying wireless communication device using the decrypted identification;
decrypting the encrypted payload decryption key using a key decryption key stored in a memory of the target wireless communication device, and a decryption algorithm stored in a memory of the target wireless communication device, to obtain a decrypted payload decryption key; and
decrypting the encrypted payload using the decrypted payload decryption key.

2. The method of claim 1, wherein at least one of the identification decryption key, the key decryption key and the decryption algorithm is stored in a first memory of the target wireless communication device, and at least one other of the identification decryption key, the key decryption key and the decryption algorithm is stored in a second memory of the target wireless communication device.

3. The method of claim 2, wherein the first memory is a subscriber identity module (SIM), and the second memory is an in-built memory of the target wireless communication device.

4. The method of claim 1, wherein the encrypted payload comprises data of a broadcast control channel (BCCH), a paging control channel (PCCH), a fast associated control channel (FACCH), an access grant channel (AGCH), a random access channel (RACH), a slow associated control channel (SACCH), or a fast associated control channel (FACCH).

5. The method of claim 1, wherein in the encrypted identification of the relaying wireless communication device comprises a scrambled concatenation of a device identifier and a subscriber identifier.

6. The method of claim 5, wherein the device identifier comprises an international mobile equipment identity (IMEI), and the subscriber identifier comprises an international mobile subscriber identity (IMSI).

7. The method of claim 1, wherein the encrypted payload decryption key is a public key.

8. The method of claim 1, further comprising:
responding to the encrypted payload using the identification of the relaying wireless communication device.

9. The method of claim 1, wherein the encrypted payload comprises a radio resource control message received using a physical channel identifier.

10. The method of claim 5, wherein the device identifier and the subscriber identifier are verified using a dedicated authentication server.

11. A target wireless communication device for managing a wireless resource, the device comprising:
computer readable program code components configured to cause receiving an encrypted identification of a relaying wireless communication device, an encrypted payload decryption key, and an encrypted payload;
computer readable program code components configured to cause decrypting the encrypted identification using an identification decryption key stored in a memory of the target wireless communication device to obtain a decrypted identification;
computer readable program code components configured to cause authenticating the relaying wireless communication device using the decrypted identification;
computer readable program code components configured to cause decrypting the encrypted payload decryption key using a key decryption key stored in a memory of the target wireless communication device, and a decryption algorithm stored in a memory of the target wireless communication device, to obtain a decrypted payload decryption key; and
computer readable program code components configured to cause decrypting the encrypted payload using the decrypted payload decryption key.

12. The target wireless communication device of claim 11, wherein at least one of the identification decryption key, the key decryption key and the decryption algorithm is stored in a first memory of the target wireless communication device, and at least one other of the identification decryption key, the key decryption key and the decryption algorithm is stored in a second memory of the target wireless communication device.

13. The target wireless communication device of claim 12, wherein the first memory is a subscriber identity module (SIM), and the second memory is an in-built memory of the target wireless communication device.

14. The target wireless communication device of claim 11, wherein the encrypted payload comprises data of a broadcast control channel (BCCH), a paging control channel (PCCH), a fast associated control channel (FACCH), an access grant channel (AGCH), a random access channel (RACH), a slow associated control channel (SACCH), or a fast associated control channel (FACCH).

15. The target wireless communication device of claim 11, wherein in the encrypted identification of the relaying wireless communication device comprises a scrambled concatenation of a device identifier and a subscriber identifier.

16. The target wireless communication device of claim 15, wherein the device identifier comprises an international mobile equipment identity (IMEI), and the subscriber identifier comprises an international mobile subscriber identity (IMSI).

17. The target wireless communication device of claim 11, wherein the encrypted payload decryption key is a public key.

18. The target wireless communication device of claim 11, further comprising:
responding to the encrypted payload using the identification of the relaying wireless communication device.

19. The target wireless communication device of claim 11, wherein the encrypted payload comprises a radio resource control message received using a physical channel identifier.

20. The target wireless communication device of claim 15, wherein the device identifier and the subscriber identifier are verified using a dedicated authentication server.
